(19) United States
(12) Patent Application Publication
(10) Pub. No.: US 2007/0183937 A1
(43) Pub. Date: Aug. 9, 2007

(54) Specimen tube with piercable end cap

(75) Inventor: Walter Sarstedt, Numbrecht (DE)

Correspondence Address: K.F. ROSS P.C., 5683 RIVERDALE AVENUE, SUITE 203 BOX 900, BRONX, NY, 10471-0900, US

(73) Assignee: SARSTEDT AG & Co.

(21) Appl. No.: 11/501,164

(22) Filed: Aug. 8, 2006

(30) Foreign Application Priority Data
Feb. 7, 2006 (DE) 202006001995.2

(51) Int. Cl. B01L 3/00

(52) U.S. Cl. 422/102; 435/283.1; 422/72

(57) ABSTRACT

A specimen tube has a tubular body having one closed end and an opposite open end, a cap having an end wall with flat outer face and an opposite inner face and a formation securing it to the open end of the tubular body, and a pierceable membrane disk pressed against the inner face of the end wall. Labeling can be applied to the end-wall outer face.

### FIELD OF THE INVENTION

The present invention relates to a specimen tube. More particularly this invention concerns such a tube with a pierceable end cap.

### BACKGROUND OF THE INVENTION

A standard specimen tube, typically for medical use holding a small quantity of liquid, e.g. blood, for analysis, consists of a tubular body which is closed at its one end and which at its opposite open end can be tightly sealed by a cap that can be pierced by the tip of a blood-drawing needle.

From DE 103 40 538 of Kolpe, such a specimen tube is known in different designs. A cap closes the open end of the body, is provided with a pierceable sealing plug, extends with a cylindrical sealing portion into the open end of the tubular body, and is sealed against the interior wall of the tubular body. They are suitable for a fully automatic withdrawal of analysis samples, to which end an insert made of rubber or an elastomer that is mounted from the top and can be pierced by the tip of a withdrawal cannula is mounted inside the sealing plug. This insert of the sealing plug consists of a material that is completely resilient and that can be easily pierced by the withdrawal cannula of the analysis device. Thus the piercing opening that is formed temporarily completely closes itself again after the needle has been pulled out.

Another sealing plug cap is known from U.S. Pat. No. 5,294,011 of Konrad. The closure for the open end of the sample vessel, in particular of blood sample vessels, comprises a sealing plug cap having a particular sealing plug mounted from the top. For secure fixing of the sealing plug in the cap, a supporting ring or respectively a securing ring is mounted into said cap from the outer, free front face.

These so-called closed systems are advantageous when working with biological samples since they reduce the danger of infection for the user (e.g. the transmission of germs) or avoid the contamination of the sample by the user (e.g. molecular biological contamination). The samples are labeled and often are transported frozen over long distances. The labeling of the samples should preferably be applied such that it is also visible when many sample vessels are fitted on end in a rack for storage.

The closed systems of the state of the art are for example used in the field of blood recovery or respectively blood withdrawal and comprise primary vessels that can retain high quantities of blood, at least 2 ml and in most cases even considerably more. In the direct adaptation, low quantities of samples of few μl are taken from the closed system. In these primary recipients, it is as well already known to provide screw caps having a pierceable and reclosable diaphragm (see U.S. Pat. No. 4,449,539). This cap closes the withdrawal tubular body at its front end and has a cylindrical punchout that projects axially and has a pierceable sealing plug. It is mounted from the top to abut a front plate of the punchout provided with a central bore and supported by a beaded flange. Due to this projecting element, it is however impossible to provide the cap end face with a label of any type.

The described closed systems of primary vessels with high filling volume are not suitable for the handling of specimen quantities that are considerably smaller than 2 ml. For analysis on chromatography devices, it is therefore common to transfer the sample and the reagent from the original vessel by means of a pipette and thus, in an open state, into the analysis vessel of the chromatography device. In the molecular biological field, the sample vessels have to be opened repeatedly for adding reagent or for taking out a part of the sample.

Each of the three mentioned systems has the disadvantage that the used sealing plugs that are made of elastomeric material are inserted and fixed from the top, i.e. from the front side. Due to this fact, no planar front face of the closing element suitable for the labeling of the sample is present.

### OBJECTS OF THE INVENTION

It is therefore an object of the present invention to provide an improved specimen tube.

Another object is to provide a closed system and at the same time, a visible labeling of the sample is possible even in the case of small quantities of liquids.

### SUMMARY OF THE INVENTION

A specimen tube has according to the invention a tubular body having one closed end and an opposite open end, a cap having an end wall with flat outer face and an opposite inner face and a formation securing it to the open end of the tubular body, and a pierceable membrane disk pressed against the inner face of the end wall.

This way a closure that is suitable for standard sample vessels is achieved that can be designed as a screw cap or a sealing plug cap and in which the complete outer surface of the cap or its end wall can be used without limitations, so that it can be provided with a label or a foil or the like without any problems associated with the known diaphragm disks that are inserted into a respectively big opening. The pierceable diaphragm disk that is inserted from the bottom or respectively from the interior and that is freely accessible for a blood-drawing needle from the outside, possibly by means of a piercing opening having a small diameter, that enables easy input or withdrawal of samples or reagents. In case of repeated removal, the diaphragm disk cannot be pressed out of the closure, since it is firmly held in its position in the closure.

This support or holding of the diaphragm washer can for example be achieved by means of an inner flange that is folded over to the interior of the closure and/or a punched disk that is inserted into the inner flange and supported by it, wherein both support the diaphragm disk. In this case, the diaphragm disk that is preferably made of rubber cannot be pressed out of the inner flange in an upward or outward direction. The flange can be advantageously fabricated by hot forming of the extremity of the inner flange.

An advantageous design of the invention provides that the front wall of the closure is unitarily formed with a plastic diaphragm that covers a piercing opening of the front wall of the closure. In this design as well, a planar, flat outer surface of the closure is present that can be fully used and, because of the thin foil, it is at the same time provided with contamination protection.

### BRIEF DESCRIPTION OF THE DRAWING

The above and other objects, features, and advantages will become more readily apparent from the following description, reference being made to the accompanying drawing in which:

FIG. 1 is a longitudinal section through a specimen tube according to the invention; and

FIG. 2 is a longitudinal section through an alternate cap in accordance with the invention.

### SPECIFIC DESCRIPTION

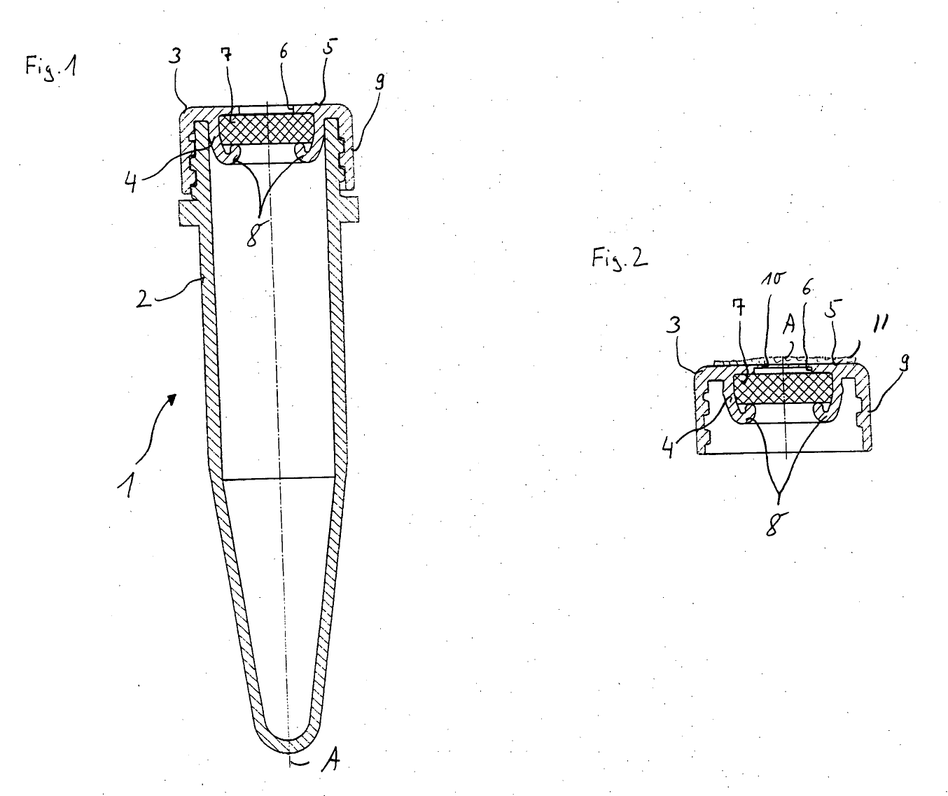

As seen in FIG. 1, a specimen tube 1 consists of a tubular glass or plastic body 2 that is closed at one end and that is intended to hold a small quantity of liquid. Its opposite upper end is closed temporarily by means of a cap 3 that can be screwed on such that the body 2 is hermetically sealed. The body 2 extends along and is centered on an axis A.

The screw cap 3 has an annular inner flange 4 and concentrical thereto a small piercing central hole opening 6 in its front or end wall 5. From the interior or bottom, a pierceable diaphragm disk 7 is inserted into the screw cap 3 in the inner flange 4 and abuts an inner face of the end wall 5. It is securely held in its position by a border 8 that is flanged by hot forming of the inner flange 4.

For sealing the screw cap 3, a sealing bead can be provided that assures a position of the closure due to which it is liquid-tight even in the case of a possible slight overpressure that can e.g. occur when reagents are added. Alternatively, it is possible to achieve a closing that seals against liquids by utilization of O-rings, sealing lips, sealing disks or the like.

The screw cap 3 described in FIG. 2 is different from the above-described design by the fact that the piercing opening 6 is covered by a thin plastic diaphragm 10 that only has the thickness of a foil or for example a thickness of 0.1 mm. FIG. 2 also shows how a label 11 can be applied to the planar outer face of the cap 2.

The screw caps 3 have in common that they close a tubular body 2 for small quantities of samples that does not have to be opened for the repeated removal of a part or a partial quantity of the sample or for multiple adding of reagents. The insertion position of the highly elastic, resilient diaphragm washer 7 that can be easily pierced by a needle is still tight even in the case of repeated piercing or pulling out of a needle or respectively a needle for taking samples, and the membrane washer 7 can as well not be pressed out of the screw cap 3. First of all, due to the mounting of the diaphragm disk 7 from the bottom, a planar, even outer surface of the end wall is present, and thus, a sufficiently large surface for the application of a labeling of the sample. This is also the case in the design as a screw cap closure with a piercing closure that can be covered by a plastic diaphragm.

I claim:

1. A specimen tube comprising:
a tubular body having one closed end and an opposite open end;
a cap having an end wall with flat outer face and an opposite inner face and a formation securing it to the open end of the tubular body; and
a pierceable membrane disk pressed against the inner face of the end wall.

2. The specimen tube defined in claim 1 wherein the outer face is planar.

3. The specimen tube defined in claim 1 wherein the membrane disk has a planar outer face bearing on the inner face of the end wall and a planar inner face turned inward into the tubular body.

4. The specimen tube defined in claim 1 wherein the body extends along and is centered on an axis, the end wall having centered on the axis an axially throughgoing hole at which an outer face of the membrane disk is exposed.

5. The specimen tube defined in claim 4 wherein the end-wall inner face is formed with an inwardly directed annular rim fitting in the open end of the body, engaging around the membrane disk, and having an inwardly turned end bearing outwardly on an inner face of the membrane disk.

6. The specimen tube defined in claim 5 wherein the rim fits snugly in the open end of the body.

7. The specimen tube defined in claim 5 wherein the end wall is formed with unitary thin foil web extending across the hole and having an outer face coplanar with the outer face of the wall.

8. The specimen tube defined in claim 7 wherein the web is about 0.1 mm thick.

9. The specimen tube defined in claim 7, further comprising
a label adhered to the outer face of the end wall and foil web.
